(19) United States
(12) Patent Application Publication
(10) Pub. No.: US 2024/0375498 A1
(43) Pub. Date: Nov. 14, 2024

(54) ARRANGEMENT FOR MOVING A COVER FOR A VEHICLE ROOF, AND VEHICLE ROOF

(71) Applicant: Webasto SE, Stockdorf (DE)

(72) Inventors: Nikolaus Georg EGER, Stockdorf (DE); Christian BECKER, Stockdorf (DE); Wenchao YANG, Stockdorf (DE); Stefan MIKLOSI, Stockdorf (DE); Mattias HIRVONEN, Stockdorf (DE); Ingo TEUFEL, Stockdorf (DE)

(21) Appl. No.: 18/657,135

(22) Filed: May 7, 2024

(30) Foreign Application Priority Data
May 9, 2023 (DE) 102023112152.9

(51) Int. Cl. B60J 7/16

(52) U.S. Cl. CPC B60J 7/1642

(57) ABSTRACT

An arrangement for a moving a cover for a vehicle roof has a guide rail, which extends along a longitudinal direction, a cover support, which is connectable to the cover, a first drive motor, a second drive motor, and a deployment lever, which is pivotable relative to the guide rail. The cover support is displaceable relative to the deployment lever along the longitudinal direction. A drive lever is guided displaceably in the guide rail along the longitudinal direction and is coupled to the cover support in order to displace the cover support along the longitudinal direction. The first drive motor is coupled to the deployment lever in order to drive a pivoting of the deployment lever, and the second drive motor is coupled to the drive lever in order to drive a displacement of the drive lever.

### CROSS-REFERENCE TO RELATED APPLICATION(S)

This application claims the benefit of German Patent Application No. 102023112152.9 filed May 9, 2023, which is incorporated herein by reference in its entirety.

### TECHNICAL FIELD

An arrangement for moving a cover for a vehicle roof is specified, in particular for a movable cover for closing a roof opening of the vehicle roof. A vehicle roof for a motor vehicle is furthermore specified, in particular a vehicle roof having an arrangement described here.

### BACKGROUND

Arrangements having a movable cover for a vehicle roof can be designed as what is referred to as an externally guided sliding roof, as described, for example, in DE 197 13 347 C2. Alternatively, it is also possible to design the vehicle roof as a what is referred to as a spoiler roof, as described, for example, in DE 10 2012 106 545 A1.

### SUMMARY

It is desirable to specify an arrangement for a vehicle roof that allows reliable operation. It is also desirable to specify a vehicle roof that allows reliable operation.

According to at least one embodiment, an arrangement for a vehicle roof is specified. The arrangement is designed for moving a cover for the vehicle roof. The arrangement has a guide rail. The guide rail extends longitudinally along a longitudinal direction. The arrangement has a cover support. The cover support is connectable to the cover. The arrangement has a first drive motor. The arrangement has a second drive motor. The arrangement has a deployment lever. The deployment lever is coupled in a positionally fixed manner to the guide rail. The deployment lever is coupled to the guide rail in such a way that the deployment lever is pivotable relative to the guide rail in order to move the cover support. The cover support is displaceable along the longitudinal direction relative to the deployment lever. The arrangement has a drive lever. The drive lever is guided displaceably along the longitudinal direction in the guide rail. The drive lever is coupled to the cover support. The drive lever and the cover support are coupled to each other in such a way that the cover support is displaceable along the longitudinal direction by means of the drive lever. The first drive motor is coupled to the deployment lever in order to drive a pivoting of the deployment lever. The second drive motor is coupled to the drive lever in order to drive a displacement of the drive lever.

The first drive motor and the second drive motor are each designed in particular as an electric motor. The arrangement has two separate drive motors in order to drive the movement of the cover support and thus the movement of the cover. The deployment lever is designed in particular to lift and lower the cover support relative to the guide rail along a vertical direction. This lifting and lowering of the cover support can be driven by means of the first drive motor. In particular, the drive lever is used to move the cover support back and forth along the longitudinal direction relative to the guide rail. The second drive motor is designed to drive this displacement of the cover support along the longitudinal direction relative to the guide rail. Thus, the cover support and therefore the cover are liftable and lowerable together by means of the first drive motor and the second drive motor and are displaceable forwards and rearwards along the longitudinal direction.

The cover is displaceable along the guide rail in the longitudinal direction in particular relative to the deployment lever. Thus, the arrangement is designed, for example, for what is referred to as a spoiler roof. The deployment lever may also be referred to as a rear deployment lever.

According to at least one embodiment, the arrangement has a deployment carriage. The deployment carriage is guided displaceably in the guide rail along the longitudinal direction. The deployment carriage is coupled to the deployment lever. The deployment carriage is coupled to the first drive motor by means of a drive cable. In particular, the drive cable is a tension- and pressure-resistant transmission cable. The first drive motor has in particular a gearwheel which is in engagement with the drive cable. Thus, the drive energy of the drive motor can be transferred to the deployment carriage by means of the drive cable. The deployment carriage is designed to perform a linear movement relative to the guide rail. This movement of the deployment carriage is transferred into a pivoting movement of the deployment lever, in particular in order to lift and lower a trailing edge of the cover.

According to at least one embodiment, the arrangement has a lifting carriage. The lifting carriage is coupled to the drive cable. The lifting carriage has a carriage slotted guide mechanism. The cover support has a slotted guide mechanism pin. The slotted guide mechanism pin is guided at least in sections in the carriage slotted guide mechanism in order to move the cover. The lifting carriage and the deployment carriage are coupled to one and the same drive cable. For example, the lifting carriage and the deployment carriage are each fastened directly to the drive cable. A relative movement between the deployment lever and the drive cable and between the lifting carriage and the drive cable along the longitudinal direction is blocked. By means of the slotted guide mechanism pin and the carriage slotted guide mechanism a movement of a leading edge of the cover can be realized in particular. In particular, the carriage slotted guide mechanism is designed in such a way that, when the deployment lever is pivoted, the leading edge of the cover is moved slightly along the longitudinal direction and the vertical direction by means of the slotted guide mechanism pin. It is thus possible, even in the case of a domed cover, to avoid a seal between the vehicle roof and the leading edge of the cover becoming undesirably severely crushed.

According to at least one embodiment, the lifting carriage and the deployment carriage are at a fixed carriage distance from each other along the longitudinal direction. The lifting carriage and the deployment carriage are coupled to each other in such a way that a relative movement between the lifting carriage and the deployment carriage along the longitudinal direction is blocked.

According to at least one embodiment, the arrangement has an articulation mechanism in order to transfer a displacement of the deployment carriage along the guide rail into a pivoting of the deployment lever, the articulation mechanism having at least four rotary joints. In particular, components of the articulation mechanism and/or of the arrangement are pivotably connected to one another by means of the rotary joints. The components are in particular levers, carriages and sliders.

For example, the arrangement has a first lever, a second lever and a third lever. The first lever is connected to the deployment carriage such that a movement of the deployment carriage along the guide rail can be transferred to the first lever. The first lever is connected pivotably to the second lever. The third lever is coupled in a positionally fixed manner to the guide rail such that the third lever is pivotable relative to the guide rail. The third lever is coupled pivotably to the second lever. The second lever is coupled pivotably to the deployment lever. The first lever, the second lever and the third lever thus form a four-bar linkage together with the deployment lever. By means of the four-bar linkage, the deployment lever is pivotable relative to the guide rail. The pivoting of the deployment lever can thus be realized by means of the first, the second and the third lever, in particular without the need for a slotted guide mechanism. This means that pivoting of the deployment lever is possible with as little friction as possible and with low driving forces. For example, two or more of the levers are pivotably connected to one another by means of one of the rotary joints of the articulation mechanism. Alternatively or in addition, for example, at least one of the levers is fastened pivotably to the guide rail by means of at least one rotary joint of the articulation mechanism. Alternatively or in addition, for example, at least one of the levers is fastened pivotably to one of the carriages by means of at least one rotary joint of the articulation mechanism.

According to at least one embodiment, the arrangement has a drive carriage. The drive carriage is guided displaceably in the guide rail along the longitudinal direction. The drive carriage is coupled to the drive lever. The drive carriage is coupled to the second drive motor by means of a further drive cable. In particular, the drive cable is a tension- and pressure-proof transmission cable. The second drive motor has in particular a gearwheel which is in engagement with the further drive cable. Thus, a drive energy of the drive motor can be transferred to the deployment carriage. The drive carriage is guided in the guide rail such that a linear movement of the drive carriage relative to the guide rail can be driven by the drive motor. The linear movement of the drive carriage leads to a displacement of the drive lever relative to the guide rail and to a pivoting of the drive lever relative to the guide rail. Thus, a longitudinal displacement of the cover support relative to the guide rail can be driven by means of the second drive motor.

According to at least one embodiment, the arrangement has a locking lever. The locking lever has a locking pin. The locking lever is arranged pivotably on the cover support. The arrangement has a locking slotted guide mechanism in the guide rail. The locking pin can be arranged in the locking slotted guide mechanism. By means of the arrangement of the locking pin in the locking slotted guide mechanism, the locking lever is held along the longitudinal direction in a positionally fixed manner with respect to the guide rail. Thus, it is possible by means of the locking lever and the locking slotted guide mechanism to hold the cover support, in particular a part of the cover support, in a positionally fixed manner with respect to the guide rail. In particular, in this state, the held part of the cover support is held immovably along the longitudinal direction relative to the guide rail. The locking pin can be disengaged from the locking slotted guide mechanism such that a relative movement between the locking lever and the guide rail and thus between the cover support and the guide rail is possible.

According to at least one embodiment, the arrangement has a spring. The spring is designed to preload the locking lever. The spring is supported in particular between the cover support and the locking lever. The spring is formed to effect preloading in a direction directed away from the cover support. In particular, the spring is designed to hold the locking pin in the locking slotted guide mechanism.

According to at least one embodiment, the cover support has a first cover support rail and a second cover support rail. The first cover support rail and the second cover support rail are locked together in a first state. In the first state, a movement along the longitudinal direction can be transferred from the second cover support rail to the first cover support rail. A relative movement between the first cover support rail and the second cover support rail along the longitudinal direction is blocked in the first state. In a second state, the first cover support rail and the second cover support rail are displaceable relative to each other along the longitudinal direction. The locking lever is arranged pivotably on the first cover support rail. The second cover support rail is fastenable rigidly to the cover.

The second cover support rail has, for example, has a cover support slotted guide mechanism. For example, the locking lever has a further locking pin. The further locking pin can be arranged, for example, in the cover support slotted guide mechanism. By means of the cover support slotted guide mechanism and the further locking pin, the locking lever can be held in a positionally fixed manner along the longitudinal direction with respect to the second cover support rail.

In the first state, the further locking pin is arranged in the cover support slotted guide mechanism such that the first cover support rail and the second cover support rail are fixed to each other along the longitudinal direction. The further locking pin is decoupled in the second state from the cover support slotted guide mechanism such that the relative movement along the longitudinal direction between the first cover support rail and the second cover support rail is possible.

According to at least one embodiment, the cover support has a guide slider. In particular, the guide slider is formed on the first cover support rail. The guide rail has a rail slotted guide mechanism. The rail slotted guide mechanism has a slotted guide mechanism region oriented along the longitudinal direction and a slotted guide mechanism region inclined with respect to the longitudinal direction. The guide slider is arranged in the inclined slotted guide mechanism region in a closing position of the arrangement. In the closing position, the cover closes the roof opening. In the closing position, a leading edge and a trailing edge of the cover are oriented substantially flush with the rest of the vehicle roof. Starting from the closing direction, the guide slider firstly moves along the inclined slotted guide mechanism region and then in the rectilinear slotted guide mechanism region. By means of the inclined slotted guide mechanism region and the guide slider, in particular lifting and lowering of a leading edge of the cover can be realized.

According to at least one embodiment, the guide slider is arranged at a first rail end of the first cover support rail facing away from the deployment lever. Alternatively or in addition, the locking lever is arranged at the first rail end of the first cover support rail facing away from the deployment lever. This allows the first cover support rail to be moved and locked in the first and second state efficiently in terms of installation space.

According to at least one embodiment, a vehicle roof for a motor vehicle has an arrangement according to at least one of the embodiments described here. The vehicle roof has a cover. The cover support is coupled to the cover in order to move the cover by means of the two drive motors. In particular, the second cover support rail is fastened rigidly to the cover. By means of the first drive motor and the second drive motor, the cover is liftable and lowerable along the vertical direction relative to the guide rail and is displaceable longitudinally along the longitudinal direction relative to the guide rail.

### BRIEF DESCRIPTION OF DRAWINGS

Further advantages, features and refinements emerge from the following examples explained in conjunction with the figures. Elements that are identical, of identical type and of identical action may be provided with the same reference signs throughout the figures.

In the drawings:

FIG. 1 shows a schematic illustration of a part of a vehicle according to an exemplary embodiment, and

FIGS. 2 to 4 each show schematic illustrations of an arrangement according to an exemplary embodiment in different views,

FIGS. 5 to 8 each show schematic illustrations of an arrangement according to an exemplary embodiment in different views,

FIGS. 9 to 18 each show schematic illustrations of an arrangement according to an exemplary embodiment in different views,

FIGS. 19 to 21 each show schematic illustrations of an arrangement according to an exemplary embodiment in different views.

### DETAILED DESCRIPTION

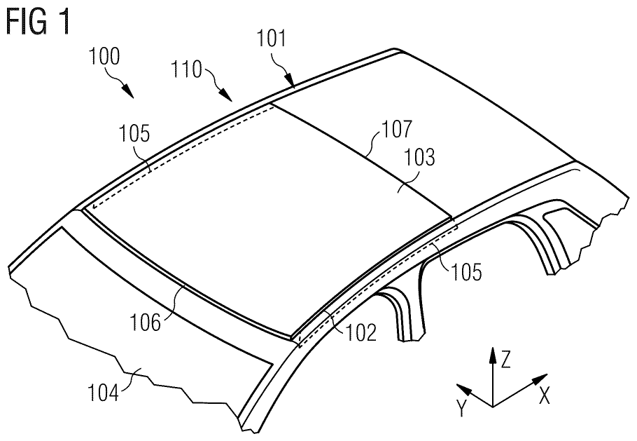

FIG. 1 shows a schematic illustration of a vehicle roof 101 of a vehicle 100. The vehicle roof 101 is in particular part of the motor vehicle 100, for example part of a passenger car. The vehicle roof 100 has an arrangement 110. The arrangement 110 has a cover 103. The cover 103 is used to close a roof opening 102. The roof opening 102 is formed in the vehicle roof 101. By means of a displacement of the cover 103 along a longitudinal direction X, the roof opening 102 can be closed in a closing position and at least partially opened up in an open position. For this purpose, the cover 103 is displaceable along the longitudinal direction X and a vertical direction Z oriented transversely with respect thereto between the closing position, which is illustrated in FIG. 1, and an open position relative to a fixed roof of the vehicle roof 101. For closing, the cover is moved counter to the longitudinal direction X.

The cover 103 has a leading edge 106 and a trailing edge 107. The trailing edge 107 is arranged in an opposite direction along the longitudinal direction X of the leading edge 106 of the cover 103. The leading edge 106 of the cover 103 faces a windscreen 104 of the vehicle 100.

The arrangement 110 has two guide rails 105. The guide rails 105 are each elongate along the longitudinal direction X. The guide rails 105 are each arranged along the transverse direction Y next to the roof opening 102. Along the transverse direction Y, the guide rails 105, for example, are each coupled to a body of the vehicle 100.

The location details or direction details used, such as rear or front, refer to the longitudinal direction X of the vehicle. The longitudinal direction of the vehicle may also be referred to as a horizontal direction or an X direction of the mathematical coordinate system. Lifting or deployment of the cover 103 is carried out along the vertical direction Z. Accordingly, location details or direction details, such as top or bottom, relate to the vertical direction Z. The region of the leading edge 106 of the cover 103 (front region of the cover 103) should be understood as meaning, for example, the region which faces from a centre of the cover along the longitudinal direction X of the windscreen 104. The longitudinal direction X, the transverse direction Y and the vertical direction Z are each in particular perpendicular to one another.

The arrangement 110 is in particular constructed identically on both sides of the roof opening 102, in particular symmetrically and corresponding to each other. Therefore, one side is described below and the side opposite the transverse direction X is of correspondingly identical type.

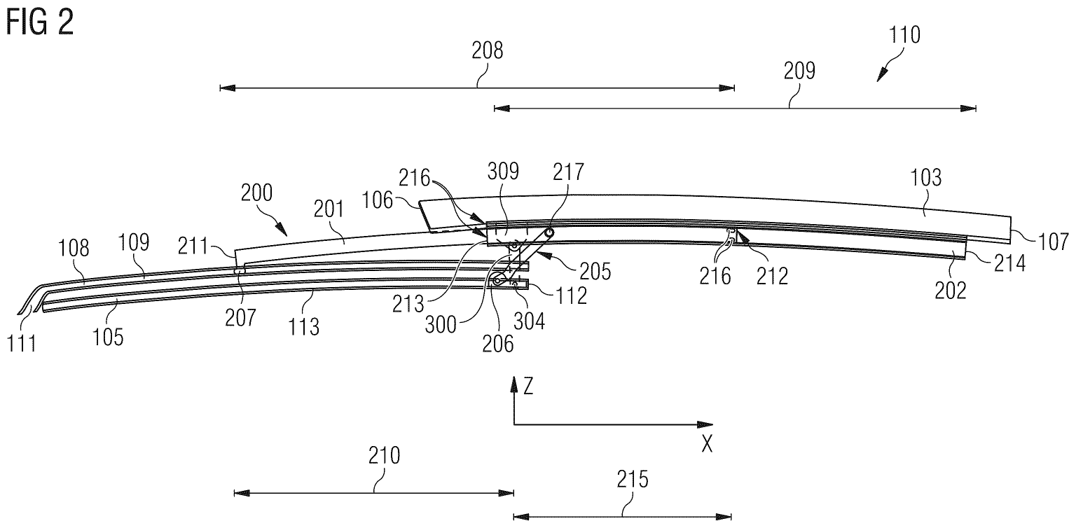

FIG. 2 shows the arrangement 110 in the open position of the cover 103. The cover 103 is displaced rearwards relative to the guide rail 105 along the longitudinal direction X such that the roof opening 102 is opened up to the maximum. The cover 103 is thus arranged along the vertical direction Z largely above the fixed vehicle roof 101.

The cover 103 is, for example, a glass cover or a plastics cover. For example, the cover 103 has an illumination functionality and/or a shading functionality and/or a heating functionality and/or a cooling functionality and/or solar cells. The cover 103 may be comparatively heavy because of the design of the arrangement 110 explained in more detail below.

The cover is coupled to the guide rail 105 by means of a cover support 200. The cover support 200 is displaceable along the longitudinal direction relative to the guide rail 105 in order to displace the cover 103 relative to the guide rail 105.

The cover support 200 has a first cover support rail 201 and a second cover support rail 202. The first cover support rail 201 and the second cover support rail 202 together form the cover support 200. The cover support 200 can be coupled on the one hand to the guide rail 105 in order to support the cover 103 on the guide rail 105. For this purpose, the cover support 200 can be coupled on the other hand to the cover 103.

The cover 103 is fastened rigidly to the second cover support rail 202. For example, the cover 103 has what is referred to as a cover inner sheet, which is foamed or glued onto a flat cover panel. The second cover support rail 202 is fastened to the cover inner sheet.

The first cover support rail 201 is held and guided in the guide rail 105. The first cover support rail 201 has a first rail end 211. A guide slider 207 is arranged at the first rail end 211. The guide slider 207 is held and guided in a rail slotted guide mechanism 108 of the guide rail 105. The guide slider 207 serves as a front support point for the cover 103 and the cover support 200. The first rail end 211 is thus assigned to the leading edge 106 and arranged facing away from the trailing edge 107 along the longitudinal direction. A distance along the longitudinal direction X between the first rail end 211 and the leading edge 106 can be changed during the moving of the cover in the second state. The first rail end 211 is spaced apart further away from the leading edge 106 in the open position than in the closing position.

The first cover support rail 201 has a second rail end 212 facing away from the first rail end 211 along the longitudinal direction X. The first cover support rail 201 is guided in the second cover support rail 202, and therefore the second rail end 212 of the first cover support rail 201 is always arranged in the second cover support rail 202.

The arrangement 110 has a deployment lever 300. The deployment lever is fastened to the guide rail 105 by means of a rotary joint 304. The deployment lever 300 is pivotable relative to the guide rail 105. The deployment lever 300 is fixed to the guide rail 105 in a positionally fixed manner along the longitudinal direction and in particular by means of the rotary joint 304. The deployment lever 300 is pivotable between a deployed position illustrated in FIG. 2 and a pivoted-in position. The deployed position is assigned to the open position of the cover 103 and the pivoted-in position to the closing position. In the pivoted-in position, the deployment lever 300 is in particular oriented primarily along the longitudinal direction X. The cover support 200 and the cover 103 are supported by means of the deployment lever 300 on a region on the guide rail 105 that is assigned to the guide rail end 112.

In the closing position, the trailing edge 107 is arranged in the region of the deployment lever 300. The trailing edge 107 is lifted from the closing position by means of pivoting of the deployment lever 300. The deployment lever 300 is in particular in engagement with the first cover support rail 201.

The arrangement 110 has a drive lever 205. The drive lever 205 is coupled in particular to the second cover support rail 202. The drive lever 205 is held and guided in the guide rail 105 by means of a drive carriage 206. The drive carriage 206 is guided displaceably in a lever track 113 of the guide rail 105 along the longitudinal direction relative to the guide rail 105.

To move the cover 103, from the closing position into the open position, the drive carriage 206 and thus the drive lever 205 are displaced rearwards along the longitudinal direction X. This displacement movement is transferred to the second cover support rail 202. The second cover support rail 202 and the drive lever 205 are coupled to each other by means of a drive lever joint 217 in such a way that a pivoting of the drive lever 205 relative to the second cover support rail 202 is possible. A longitudinal displacement between the drive lever 205 and the second cover support rail 202 along the longitudinal direction is blocked.

In a first movement section, starting from the closing position, the first cover support rail and the second cover support rail 202 are locked together and/or latched together. Thus, the movement of the drive lever 205 is transferred to the first cover support rail 201 by means of the second cover support rail 202.

The guide slider 207 is thus moved along the rail slotted guide mechanism 108. At its front end, the rail slotted guide mechanism 108 has an inclined slotted guide mechanism region 111, which is arranged opposite the guide rail end 112 along the longitudinal direction X. This is followed by a rectilinear slotted guide mechanism region 109. The leading edge 106 is first of all lifted by means of the inclined slotted guide mechanism region 111. Subsequently, a rectilinear displacement along the longitudinal direction X is realized by means of the rectilinear slotted guide mechanism region 109. The cover support 200 and in particular the first cover support rail 201 are displaced in the locked state together with the second cover support rail 202 relative to the deployment lever 300 along the longitudinal direction X.

In a second movement section or in a second state, the lock between the first cover support rail 201 and the second cover support rail 202 is released. The first cover support rail 201 is instead locked to the guide rail 105, and therefore a longitudinal displacement of the first cover support rail 201 and the guide rail 105 relative to each other is blocked. Thus, the first cover support rail 201 is held in the position illustrated in FIG. 2.

The second cover support rail 202 is displaceably further rearwards relative to the first cover support rail 201 in a manner driven by the drive lever 205. In this case, the second cover support rail 202 is supported on the first cover support rail 201 and thus on the guide rail 105. The cover 103 is thus displaceable further rearwards and is nevertheless supported comparatively far forwards by means of the first cover support rail 201 and the guide slider 207 arranged at its first rail end 211.

The second cover support rail 202 is displaceable further rearwards relative to the guide rail 105 and the deployment lever 300 until the open position illustrated in FIG. 2 is reached.

In the open position, the guide slider 207 and the deployment lever 300 are at the first support distance 210. For example, the first support distance 210 corresponds to at least one third of a length of the guide rail 105, in particular at least half of the length of the guide rail 105. The length of the guide rail 105 results in particular from the distance of the inclined slotted guide mechanism region 111 from the guide rail end 112 along the longitudinal direction X. The first support distance 210 corresponds, for example, to at least one third or at least half of the length of the first cover support rail 201 along the longitudinal direction X between the first rail end 211 and the second rail end 212.

The first cover support rail 201 protrudes in the open position at least over the length of a second support distance 215 into the second cover support rail 202. The second rail end 212 can thus be arranged comparatively far rearwards over the fixed region of the vehicle roof 101. Thus, the cover 103 is reliably supported on the guide rail 105 because of the second rail end 212 arranged comparatively far rearwards and the first rail end 211 arranged comparatively far forwards. The first rail end 211 and the second rail end 212 are arranged comparatively far apart from each other and in particular also comparatively far away from the deployment lever 300. This results in favourable lever ratios for supporting the cover 103 in the open position. This permits the cover to be positioned rearwards to a great extent in the open position, and nevertheless reliably supports and holds the cover 103.

In the open position, a third rail end 213 of the second cover support rail 202 is arranged in the region of the deployment lever 300. The third rail end 213 may also be referred to as the front end of the second cover support rail 202. Along the longitudinal direction X, the second cover support rail 202 has a fourth rail end 214, which may also be referred to as the rear end of the second cover support rail 202. The fourth rail end 214 is assigned to the trailing edge 107 of the cover. The third rail end 213 is assigned to the leading edge 106 of the cover. In the open position, the second rail end 212 of the first cover support rail 201 is arranged along the longitudinal direction between the third rail end 213 and the fourth rail end 214 of the second cover support rail 202. For example, the second rail end 212 is arranged in a central region between the third rail end 213 and the fourth rail end 214.

The first cover support rail 201 has a longitudinal extent 208. The second cover support rail 202 has a longitudinal extent 209 along the longitudinal direction X.

The longitudinal extent 208 of the first cover support rail 201 is, for example, approximately the same length as the second longitudinal extent 209 of the second cover support rail 202. In the open position, the longitudinal extents 208, 209 overlap, as illustrated in FIG. 2, and therefore the third rail end 213 is arranged between the first rail end 211 and the second rail end 212 and the second rail end 212 between the third rail end 213 and the fourth rail end 214. In the open position, the distance between the first rail end 211, which forms a front end of the cover support 200, and the fourth rail end 214, which forms a rear end of the cover support 200, is greater than the longitudinal extent 208 and greater than the longitudinal extent 209. A distance between the first rail end 211 and the fourth rail end 214 is in particular changeable and is smaller in the closing position than in the open position. Thus, the total length of the cover support 200 can be changed because of the displaceability of the two cover support rails 201, 202 relative to each other along the longitudinal direction X.

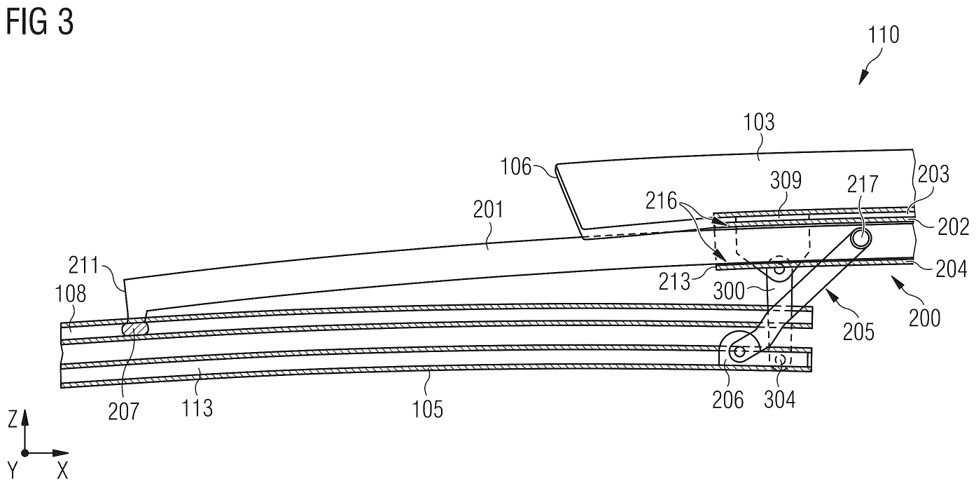

As also illustrated in FIG. 3, at least one rail slider 216 is arranged on an inside of the second cover support rail 202. In particular, rail sliders 216 are in each case formed at the third rail end 213 and at the fourth rail end 214. The rail sliders 216 are, for example, made of a plastic or other friction-reducing material. The rail sliders 216 are each arranged in particular along the vertical direction Z and/or the transverse direction Y between the first cover support rail 201 and the second cover support rail 202. The rail sliders 216 reduce the friction between the first cover support rail 201 and the second cover support rail 202, and therefore a low-friction displacement of the two cover support rails 201, 202 relative to each other is possible. Alternatively or additionally, the rail sliders 216 are each designed to damp vibrations and/or sound transmission. This makes it possible to reduce noise emissions caused, for example, by vibrations of the cover 103 during operation in the open position. These vibrations are damped by means of the rail sliders 216 and are thus introduced only to a reduced extent into the guide rail 105 and therefore into the vehicle body.

It is also apparent in FIG. 3 that, in the open position, the drive lever 205 and the deployment lever 300 are arranged next to each other and intersecting. The drive lever 205 and the deployment lever 300 are offset along the Y direction. Along the longitudinal direction X, the deployment lever 300 is oriented substantially along the vertical direction Z and the drive lever 205 is oriented obliquely thereto. In a projection onto an XY plane, the rotary joint 304 is arranged along the longitudinal direction X between the drive carriage 206 and the drive lever joint 217.

The deployment lever 300 is coupled to the cover support 200 by means of a deployment lever slider 309. The second cover support rail 202 and the deployment lever slider 309 are coupled slidingly to each other such that the movement along the longitudinal direction X is possible, but a movement along the vertical direction Z and a movement along the transverse direction Y between the deployment lever 309 and the second cover support rail 202 are blocked. The deployment lever slider 309 and the deployment lever 300 are coupled pivotably to each other in order to permit pivoting of the deployment lever 300 relative to the guide rail 105 and to the cover support 200.

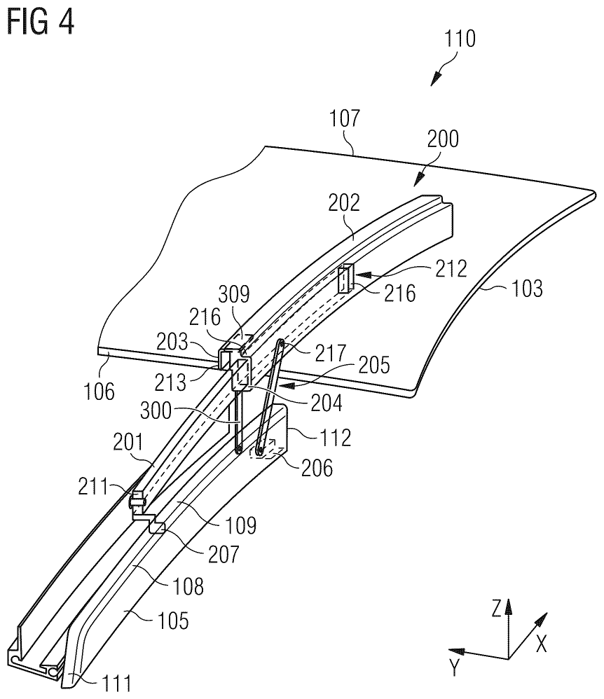

A first sliding track 203 and a second sliding track 204 of the second cover support rail 202 are visible in FIG. 4. The two sliding tracks 203, 204 are arranged laterally offset from each other along the Y direction. The two sliding tracks 203, 204 extend in each case mainly along the longitudinal direction X. The second cover support rail 202 is thus wider along the transverse direction Y than the first cover support rail 201.

The first cover support rail 201 is guided in the second sliding track 204. The deployment lever 300 and in particular the deployment lever slider 309 are guided in the first sliding track 203. It is possible for the first sliding track 203 and the second sliding track 204 to be offset with respect to each other along the vertical direction Z, in particular in order to follow a curvature of the cover 103. For example, the deployment lever slider 309 has a T shape at its end facing the cover 103. The sliding track 203 has a corresponding profile, and therefore the T shape of the deployment lever slider 309 can reliably engage in the first sliding track 203.

The second sliding track 204 has a substantially rectangular cross section, which is matched to an outer shape of the first cover support rail 201.

For example, the rear cover slider 216 is fastened to the second rail end 212 of the first cover support rail 201 and moves together with the first cover support rail 201 relative to the second cover support rail 202. The front rail slider 216 is, for example, fastened rigidly on the second cover support rail 202 at the third rail end 213 to the second cover support rail 202.

The first cover support rail 201 moves less far along the longitudinal direction between the closing position and the open position than the cover 103. In the closing position, the cover 103 is moved further rearwards along the longitudinal direction X than the first cover support rail 201. A sufficient distance can thus be realized between the guide slider 207, which forms a front support, and the deployment lever slider 309, which realizes a rear support of the cover support 200 and in particular of the first cover support rail 201.

For example, the first cover support rail 201 and the second cover support rail 202 are latched together in the first state, and therefore the drive movement of the drive carriage 206 is transferable to the first cover support rail 201. It is also possible for the drive carriage 206 and the guide slider 207 to be locked together such that, in the first state, the movement along the longitudinal direction is transferable to the first cover support rail. For example, a drive rod, which is optionally coupled to or decoupled from the first cover support 201, is provided for this purpose. For example, the drive movement is also transferred indirectly or directly to the deployment lever 300, and therefore the lifting and lowering of the deployment lever 300 is also driven by the drive. For this purpose, for example, a slotted guide mechanism, a drive rod or another transmission element is also provided.

It is also possible for the arrangement 110 to have two or more drives. For example, one drive is provided to move the deployment lever 300. Another drive is provided, for example, to move the guide slider 207. A third drive is provided, for example, to move the drive carriage 206. It is also possible to provide only two drives, with for example, one drive driving both the drive carriage 206 and the guide slider 207 and the second drive driving the pivoting of the deployment lever 300.

As a result of the fact that the first rail end 211 can be arranged in the open position along the longitudinal direction X far in front of the leading edge 106, increased distances between the support points of the cover support 200 on the guide rail 105 can be produced. The drive carriage 206 is arranged in the open position along the longitudinal direction X between the first rail end 211 and the second rail end 212. The drive carriage 206 is displaceable into the second state relative to the guide slider 207 along the longitudinal direction X. The comparatively large distance between the support points of the cover support 200 permits reduced loads at the support points. Thus, greater opening widths for the cover 103 can be realized in the open position. Alternatively or in addition, it is possible to use the cover 103 with larger masses. For example, the first cover support rail 201 extends in the open position along half of its longitudinal extent 208+/−10% outside the second cover support rail 201 and with the rest of its longitudinal extent 208, therefore in particular half+/−10%, within the second cover support rail 202.

The second cover support rail 202 is directly connectable to the drive lever 205, and therefore the length of the guide rail 105 can be used usefully to push the drive carriage 206 and thus the drive lever 205 and thus the second cover support rail 202 and thus the cover 103 in the open position as far rearwards as possible. The arrangement of the drive carriage 206, which is laterally offset in the Y direction, and of the deployment lever 300 also usefully contributes thereto.

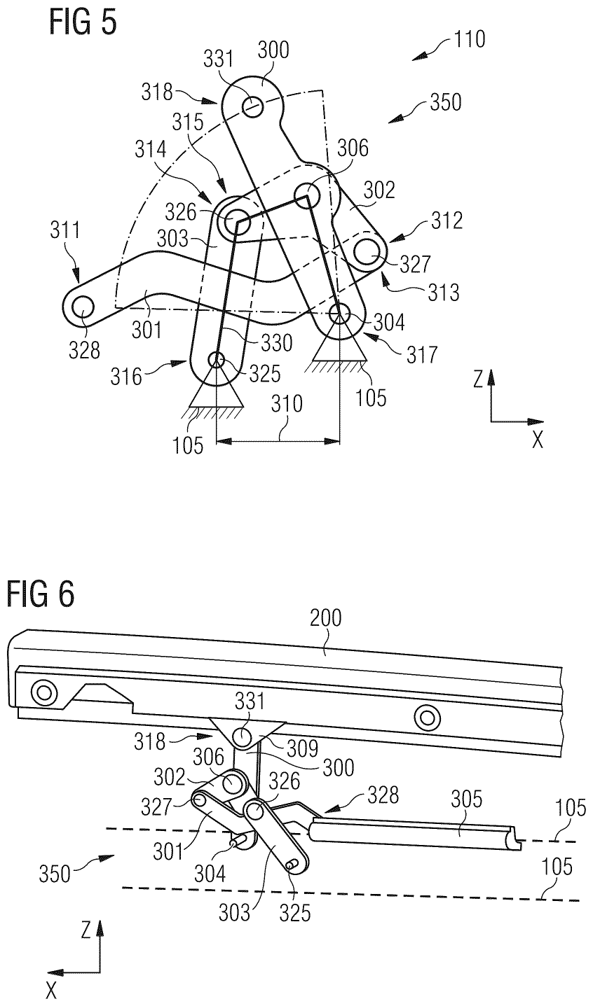

FIGS. 5 and 6 show the arrangement 110. The arrangement 110 has an articulation mechanism 350.

The arrangement 110 has a first lever 301. The first lever extends between a first end 311 and an opposite second end 312 along the longitudinal direction X. The first lever 301 extends in particular between a deployment carriage 305 and a second lever 302.

The deployment carriage 305 is displaceable longitudinally in the guide rail 105. In particular, the deployment carriage 305 is displaceable forwards and rearwards relative to the guide rail 105 along the longitudinal direction X by means of a drive, not explicitly illustrated, for example by means of an electric motor.

The first lever 301 is connected at the first end 311 to the deployment carriage 305, and therefore the first end 311 of the first lever 301 follows a longitudinal movement of the deployment carriage 305. Pivoting of the first lever 301 relative to the guide rail 105 and relative to the deployment carriage 305 is possible.

At the second end 312, the first lever 301 is connected to the second lever 302. The first lever 301 is connected at the second end 312 to a third end 313 of the second lever 312. The first lever 301 and the second lever 302 are connected pivotably relative to each other at the second end 312 and the third end 313.

The second lever 302 extends between the third end 313 and a fourth end 314. At the fourth end 314, the second lever 302 is connected to a third lever 303. The second lever 302 is connected to a fifth end 315 of the third lever 303. At the fourth end 314 and the fifth end 315, the second lever 302 and the third lever 303 are connected pivotably to each other relative to each other.

The third lever 303 extends rectilinearly between the fifth end 315 and an opposite sixth end 316. The sixth end 316 is connected in a positionally fixed manner to the guide rail 105. At the sixth end 316, the third lever 303 is pivotable relative to the guide rail 105. However, a movement along the longitudinal direction X is blocked.

The arrangement 110 has a deployment lever 300. The deployment lever 300 is connected in a positionally fixed manner to the guide rail at a seventh end 317. The deployment lever 300 is pivotable at the seventh end 317 relative to the guide rail. A longitudinal displacement of the seventh end 317 along the longitudinal direction X relative to the guide rail 105 is blocked.

The deployment lever 300 extends longitudinally between the seventh end 317 and an opposite eighth end 318. The eighth end 318 can be coupled to the cover support 200. The cover support 200 is coupled to the cover 103 to support the cover 103. The coupling between the deployment lever 300 and the cover support 200 has a deployment lever slider 309. The deployment lever slider 309 is guided slidingly in the cover support 200 such that the cover support 200 is displaceable along the longitudinal direction relative to the deployment lever slider 309. The deployment lever slider 309 is fastened to the deployment lever 300 pivotably with respect to the deployment lever 300 by means of a seventh rotary joint 331 at the eighth end 318.

The deployment lever 300 is fastened to the guide rail 105 at the seventh end 317 by means of a rotary joint. The rotary joint permits the guide rail 105 and the deployment lever 300 to pivot relative to each other and blocks a longitudinal displacement along the longitudinal direction.

A sixth rotary joint 306 is provided in a central region of the deployment lever 300 between the seventh end 317 and the eighth end 318. At the sixth rotary joint 306, the deployment lever 300 is coupled to the second lever 302. The sixth rotary joint 306 fastens the deployment lever 300 and the second lever 302 together such that a pivoting of the deployment lever 300 and the second lever 302 relative to each other is possible. A longitudinal displacement is blocked by means of the sixth rotary joint 306. The sixth rotary joint 306 is arranged on a central region of the second lever 302 between the third end 313 and the fourth end 314.

The third lever 303 is fastened in a positionally fixed manner to the guide rail 105 by means of a second rotary joint 325. The second rotary joint 325 permits the second lever 303 and the guide rail 105 to pivot relative to each other. A longitudinal displacement along the longitudinal direction X is blocked.

The third lever 303 and the second lever 302 are fastened to each other by means of a third rotary joint 326. The third rotary joint 326 permits the third lever 303 and the second lever 302 to pivot relative to each other. A longitudinal displacement along the longitudinal direction X is blocked.

The second lever 302 and the first lever 301 are fastened to each other by means of a fourth rotary joint 327. The fourth rotary joint 327 permits the second lever 302 and the first lever 301 to pivot relative to each other. A longitudinal displacement along the longitudinal direction X between the second lever 302 and the first lever 301 is blocked.

The first lever 301 is fastened to the deployment carriage 305 by means of a fifth rotary joint 328. The fifth rotary joint 328 permits the first lever 301 and the deployment carriage 305 to pivot relative to each other. A longitudinal displacement of the first lever 301 and the deployment carriage 305 relative to each other along the longitudinal direction X is blocked by means of the fifth rotary joint 328.

The rotary joint 304 for fastening the deployment lever 300 and the second rotary joint 325 for fastening the third lever 303, in each case to the guide rail 105, are arranged spaced apart from each other at a distance 310 along the longitudinal direction X. For example, the rotary joint 304 and the second rotary joint 325 are also arranged offset to each other along the vertical direction Z. For example, the second rotary joint 325 is arranged along the vertical direction Z below the rotary joint 304. The second rotary joint 325 is arranged, for example, along the longitudinal direction X further forwards than the rotary joint 304.

The deployment lever 300, the first lever 301, the second lever 302 and the third lever 303 are part of a common four-bar linkage. The first lever 301, the second lever 302 and the third lever 303 are used to pivot the deployment lever 300. By means of the pivoting of the deployment lever 300, the cover support 200 can be lifted and lowered relative to the guide rail 105 along the vertical direction Z. In particular, by means of the pivoting of the deployment lever 300, the trailing edge 107 of the cover 103 can be lifted and lowered relative to the guide rail 105 along the vertical direction Z.

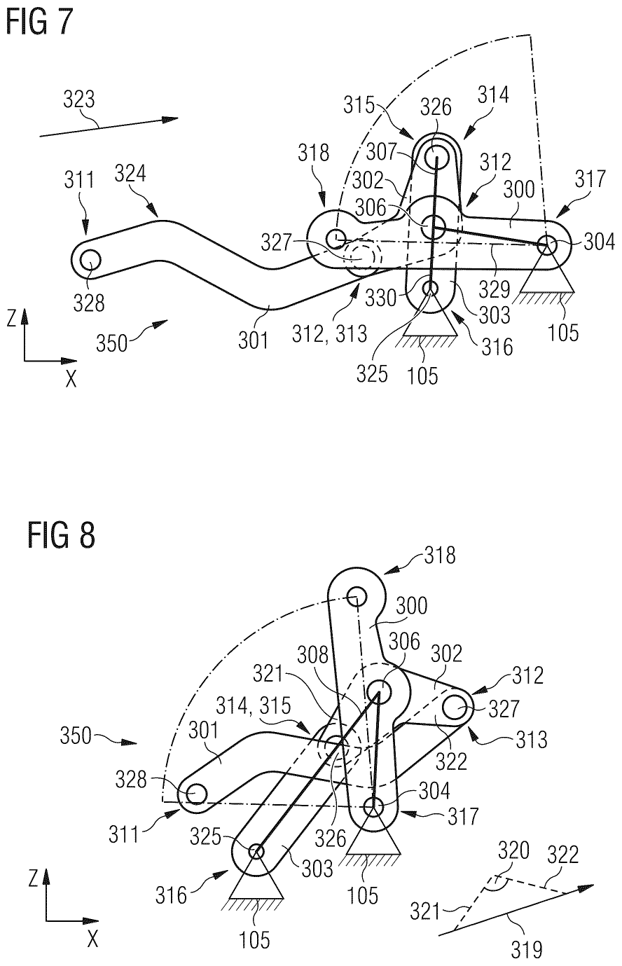

FIG. 7 shows the arrangement 110 and the articulation mechanism 350 in a closing position. In the closing position, the cover 103 closes the roof opening 102. Starting from the closing position, the cover 103 can be lifted along the longitudinal direction Z and moved to the rear along the longitudinal direction X, i.e. in a direction away from the windscreen 104.

First of all, starting from the closing position, the trailing edge 107 of the cover can be lifted by means of the deployment lever 300, wherein the leading edge 106 is not yet substantially lifted over the rest of the vehicle roof 101. This position is referred to as the tilt position.

Subsequently, the leading edge 106 can also be lifted and the entire cover 103 can be displaced rearwards along the longitudinal direction X in order to open up the roof opening. This so-called open position is illustrated in FIG. 8.

In the closing position according to FIG. 7, the deployment lever 300 is pivoted in, and therefore a main direction of extent 329 of the deployment lever 300 substantially runs along the longitudinal direction X. The eighth end 318 is arranged close to the guide rail 105. Thus, the cover 103 is held close to the guide rail 105.

The third lever 303 is oriented in such a way that the fifth end 315 is arranged along the vertical direction Z above the sixth end 316. A main direction of extent 330 of the third lever 303 runs substantially along the vertical direction Z. Thus, the third lever 303 is reliably supported on the guide rail 105 along the vertical direction Z and in particular without relevant torque.

The sixth rotary joint 306 is arranged in the closing position along the vertical direction Z between the second rotary joint 325 and the third rotary joint 326. The second rotary joint 325, the sixth rotary joint 306 and the third rotary joint 326 are arranged along a straight line 307. The straight line 307 runs substantially along the vertical direction Z. The fifth end 315, the sixth rotary joint 306 and the sixth end 316 are arranged on the straight line 307. Thus, a pivoting of the deployment lever 300 and in particular a lifting of the eighth end 318 is not possible without the action of an external torque by means of the second lever 302. The sixth rotary joint 306, the second rotary joint 325 and the third rotary joint 326 are in a dead centre position. Thus, the cover 103 is securely held in the closing position.

Starting from the closing position in FIG. 7, the arrangement 110 for lifting the trailing edge 107 is moved into the open position according to FIG. 8. This movement takes place in particular driven by a longitudinal movement of the deployment carriage 305 relative to the guide rail 105 rearwards, i.e. in particular away from the windscreen 104. The displacement of the deployment carriage 305 causes a displacement of the first end 311 of the first lever 301. Thus, the second end 312 of the first lever 301 is also displaced along the longitudinal direction X and the first lever 301 is pivoted relative to the guide rail about the fifth rotary joint 328. The coupling of the first lever 301, the second lever 302, the third lever 303 and the deployment lever 300 causes the linear movement of the deployment carriage 305 to be transferred into the various pivoting movements of the levers 300, 301, 302, 303.

The second end 312 moves along the longitudinal direction firstly in the direction of the rotary joint 304 and further beyond the latter. In the closing position, the second end 312 is arranged in front of the rotary joint 304. In the open position, the second end 312 is arranged behind the rotary joint 304, in each case along the longitudinal direction X.

This displacement of the second end 312 and thus also of the fourth rotary joint 327 causes a movement and rotation of the second lever 302. Since the latter is connected at the fourth end 314 to the third lever 303, and is connected at the sixth rotary joint 306 to the deployment lever 300, the displacement of the second end 312 is converted by means of the second lever 302 and the third lever 303 into the pivoting movement of the deployment lever 300.

In the open position, the sixth rotary joint 306, the third rotary joint 326 and the second rotary joint 325 are arranged along a straight line 308. The third rotary joint 326 is arranged along the straight line 308 between the sixth rotary joint 306 and the second rotary joint 325. The sixth end 316 and the fifth end 315 and the sixth rotary joint 306 are arranged along the straight lines 308. The fourth end 314 and the fifth end 315 are arranged between the sixth rotary joint 306 and the second rotary joint 325 on the straight line 308. The straight line 308 connects the second rotary joint 325 and the sixth rotary joint 306. In the closing position, the third rotary joint 326 and the sixth rotary joint 306 are arranged substantially along the vertical direction Z one above the other on the straight line 307.

In the open position, the sixth rotary joint 306 is arranged along the longitudinal direction X between the third rotary joint 326 and the fourth rotary joint 327.

The fourth rotary joint 327 is arranged in the closing position along the longitudinal direction X in front of the sixth rotary joint 306 and in the open position behind the sixth rotary joint 306.

The third rotary joint 326 is arranged in the open position along the longitudinal direction X between the rotary joint 304 and the second rotary joint 325. The sixth rotary joint 306 is arranged along the vertical direction Z above the rotary joint 304. The third rotary joint 326 is arranged on the straight line 306 between the sixth rotary joint 306 and the second rotary joint 325. Thus, a dead centre position is produced for the sixth rotary joint 306, the third rotary joint 326 and the second rotary joint 325. The pivoted-out position of the deployment lever 300 in the tilt position and in the open position is thus kept stable. Without an action of a torque by means of the second lever 302, the deployment lever 300 is reliably held in its pivoted-out position and the cover 103 is thus supported in a stable manner.

The second lever 302 has a main direction of extent 319, which is illustrated schematically in FIG. 8. The second lever 302 has a first section 321 and a second section 322, which are also illustrated schematically in FIG. 8 for better understanding. The fourth end 314 of the second lever 302 is formed on the first section 321. The second end 312 is formed on the second section 322. The sixth rotary joint 306 is formed in a central region in which the first section 321 and the second section 322 adjoin each other. The first section 321 and the second section 322 are at an angle 320 to each other. In particular, a connecting line between the sixth rotary joint 306 and the third rotary joint 326 is at the angle 320 with respect to a connecting line between the sixth rotary joint 306 and the fourth rotary joint 327. The angle 320 has in particular a value of greater than 90° and less than 180°. The sixth rotary joint 306, the third rotary joint 326 and the fourth rotary joint 327 are thus arranged in a triangular shape relative to one another.

The first lever 301 has a main direction of extent 323. The main direction of extent 323 of the first lever 301 is illustrated schematically in FIG. 7. The first lever 301 has a curved profile 324 along the main direction of extent 323. The first lever 301 thus does not run along a single straight line, but has sections that run at an angle to each other. Thus, a space-efficient arrangement of the third rotary joint 326, the fourth rotary joint 327 and in particular of the sixth rotary joint 306 relative to each other is possible. In particular, the curved profile 324 makes it possible for the first lever 301 to run below the second lever 302 in the open position and nevertheless for the fourth rotary joint 327 to be realized. The third rotary joint 326 can also be arranged above the first lever 301 in the open position.

To lift and lower the cover 103 in the rear region at the trailing edge 107, the deployment lever 300, which is designed as a movable link of the four-bar linkage, is used. The two other links, that is, the second lever 302 and the third lever 303, of the four-bar linkage are arranged in such a manner that, in the closed and in the open position, i.e. in the respective end positions, of the deployment lever 300 a dead centre position is in each case produced.

The drive is carried out by means of the first lever, which is connected to the second lever 302. In an alternative exemplary embodiment, which is not explicitly illustrated in the figures, the first lever 301 is pivotably coupled to the sixth end 316 of the third lever 303. Accordingly, in this exemplary embodiment, the second end 312 of the second lever 302 is connected pivotably in a positionally fixed manner to the guide rail 105.

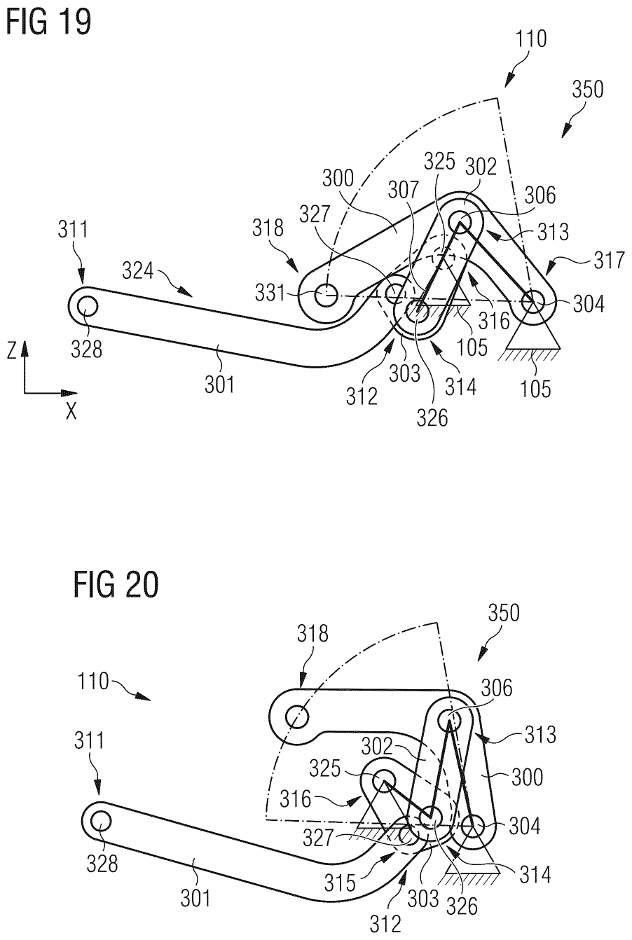

FIGS. 19 to 21 show the arrangement 100 with the articulation mechanism 350 according to a further exemplary embodiment. The functionality and configuration of the articulation mechanism 350 substantially corresponds to the exemplary embodiment according to FIGS. 5 to 8.

In contrast to the exemplary embodiment according to FIGS. 5 to 8, the first lever 301 is pivotably connected by the fourth rotary joint 327 to the third lever 303. The second lever 302 runs in a straight line between the third rotary joint 326 and the sixth rotary joint 306. The second lever 302 is connected to two rotary joints 306, 326. The third lever 303 is connected to the three rotary joints 325, 326, 327.

The third lever 303 has a basic triangular shape. The third rotary joint 326 and the fourth rotary joint 327 are at a smaller distance from each other than the second rotary joint 325 from the third rotary joint 326 and than the second rotary joint 325 from the fourth rotary joint 327.

The deployment lever 300 has an angled profile. The seventh end 317 of the deployment lever 300 is formed on a first section of the deployment lever 300. The eighth end 318 is formed on a second section of the deployment lever 300. The sixth rotary joint 306 is formed in a central region in which the first section and the second section adjoin each other. The first section and the second section are at an angle to each other. In particular, a connecting line between the sixth rotary joint 306 and the first rotary joint 304 is at the angle with respect to a connecting line between the sixth rotary joint 306 and the seventh rotary joint 331. The angle 320 has in particular a value of greater than 90° and less than 180°. The sixth rotary joint 306, the third rotary joint 326 and the fourth rotary joint 327 are thus arranged in a triangular shape relative to one another.

FIG. 19 shows the arrangement 110 in the closing position. The third rotary joint 326, the second rotary joint 325 and the sixth rotary joint 306 are arranged along the straight line 307. The second rotary joint 325 is arranged along the straight line 307 between the third rotary joint 326 and the sixth rotary joint 306. Thus, a pivoting of the deployment lever 300 and in particular a lifting of the eighth end 318 is not possible without the action of an external torque by means of the second lever 302. The sixth rotary joint 306, the second rotary joint 325 and the third rotary joint 326 are in a dead centre position. Thus, the cover 103 is securely held in the closing position.

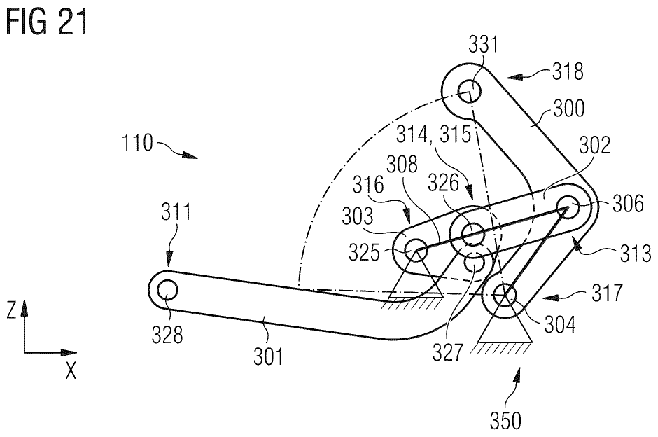

FIG. 21 shows the arrangement 110 in the open position. The sixth rotary joint 306, the third rotary joint 326 and the second rotary joint 325 are arranged along the straight line 308. The third rotary joint 326 is arranged along the straight line 308 between the second rotary joint 325 and the sixth rotary joint 306. Thus, a dead centre position is produced for the sixth rotary joint 306, the third rotary joint 326 and the second rotary joint 325. The pivoted-out position of the deployment lever 300 in the tilt position and in the open position is thus kept stable. Without an action of a torque by means of the second lever 302, the deployment lever 300 is reliably held in its pivoted-out position and the cover 103 is thus supported in a stable manner.

FIG. 20 shows the arrangement 110 in an intermediate position between the open position and the closing position.

The arrangement 100 according to the various exemplary embodiments permits a pivoting of the deployment lever 300 and thus a lifting and lowering of the trailing edge 107 only with rotary joints, with slotted guide mechanisms being avoided. This permits comparatively low torques to overcome the bearing friction in the rotary joints 304, 306 and 325 to 328, even at higher loads. In particular, this bearing friction is significantly lower than the friction in a slotted guide mechanism.

The arrangement 110 has the articulation mechanism 350 for lifting and lowering the trailing edge 107. The articulation mechanism 350 has at least three rotary joints in order to pivotably connect the levers 300, 301, 302, 303 to one another. The articulation mechanism 350 has at least the third rotary joint 326, the fourth rotary joint 327 and the sixth rotary joint 306. In addition, the articulation mechanism has, for example, the fifth joint 328 in order to pivotably connect the first lever 301 to the deployment carriage 305. In addition, the articulation mechanism has, for example, the first rotary joint 304 and the second rotary joint 325, which are each in a fixed position with respect to the guide rail 105. In addition, the articulation mechanism has, for example, the seventh rotary joint in order to pivotably connect the deployment lever 300 and the deployment lever slider 309 to each other. By means of the seventh rotary joint, it is possible to pivot the deployment lever 300 and the cover support 200 relative to each other. The articulation mechanism 350 is thus formed in the manner of a type of four-bar linkage, in particular in the manner of a four-bar linkage.

Small bearing clearances in the rotary joints 304, 306 and 325 to 328 can be realized technically reliably. This permits efficient root cause analysis in the event of faults occurring, such as sluggishness, rattling and/or jolting, and appropriate intervention options to remove said faults.

Starting from the closing position according to FIG. 7 or FIG. 19, a comparatively low drive force requirement is first of all necessary for deploying the lever 300. For example, at the beginning of the deployment movement of the deployment lever 300, the bearing friction has to be substantially overcome. A comparatively far displacement of the deployment carriage 305 leads to a comparatively small pivoting of the deployment lever 300. Thus, the pivoting of the deployment lever 300 can be realized with a comparatively low application of force to the deployment carriage 305.

During the further course of the pivoting movement 300, for example in the region according to FIG. 5 or FIG. 20, the drive force requirement increases steadily to a maximum and falls again to a lower level before reaching the open position according to FIG. 8 or FIG. 21, in particular the drive force requirement decreases steadily.

In the middle movement section for pivoting the deployment lever 300, a comparatively small travel of the deployment carriage 305 along the longitudinal direction X relative to the guide rail 105 is thus converted into a large pivoting movement of the deployment lever 300, for which the large drive force requirement is necessary.

Subsequently, in turn, a comparatively far displacement of the deployment carriage 305 along the guide rail 105 is converted into a smaller pivoting of the deployment lever 300 until the end position according to FIG. 8 or FIG. 21 is reached. For this purpose, in turn, the lower drive force requirement is sufficient.

The drive force profile along the entire pivoting movement of the deployment lever 300 is known and can be stored, for example, in a control device for the drive. The known and in particular continuous drive force profile enables simple and efficient obstacle detection, such as reliable anti-pinching protection. A control device does not have to distinguish between increased friction, which occurs, for example, in the case of slotted guide mechanisms, and an increase in the drive force requirement due to an obstacle. It is known in particular at any time of the pivoting movement of the drive lever 300 which drive force requirement is necessary for an obstacle-free pivoting. If there is a deviation from this drive force requirement, an obstacle can easily be detected.

In the event of a movement from the open position to the closing position, high forces can occur, in particular at the end of the closing movement, due to wind load and sealing pressure, which lead to a higher drive force requirement for the final closing of the cover 103 in the roof opening 102. This is compensated for by the transmission ratio formed by means of the four-bar linkage. The comparatively large travel of the deployment carriage 305 along the guide rail 105 has to bring about only a small pivoting of the deployment lever 300 towards the closing position according to FIG. 7 or FIG. 19.

The deployment lever 300 can be designed with a reliable rigidity along the transverse direction X. Thus, the arrangement 110 with the cover 103 can be realized with good vibration behaviour.

In the end positions according to FIGS. 7 and 8 or FIGS. 19 and 21, the four-bar linkage of the articulation mechanism 350 cannot be driven by means of the deployment lever 300. The deployment lever 300 is locked in the end positions. Thus, an additional locking in particular of the first lever 301 in the end positions according to FIGS. 7 and 8 or FIGS. 19 and 21 can be dispensed with.

The cover support 200 is formed in one piece in particular according to a conventional cover support. It is also possible to form the cover support in multiple parts and with cover support rails which are displaceable along the longitudinal direction X relative to each other during operation.

The deployment carriage 305 is in particular directly connected to a tension- and pressure-resistant drive cable, not illustrated explicitly. The drive cable in turn is connected to the drive, i.e. in particular to the electric motor, in order to transmit a driving energy of the electric motor to the deployment carriage 305.

The arrangement 110 permits a reliable, low-friction and force-efficient pivoting of the deployment lever 300.

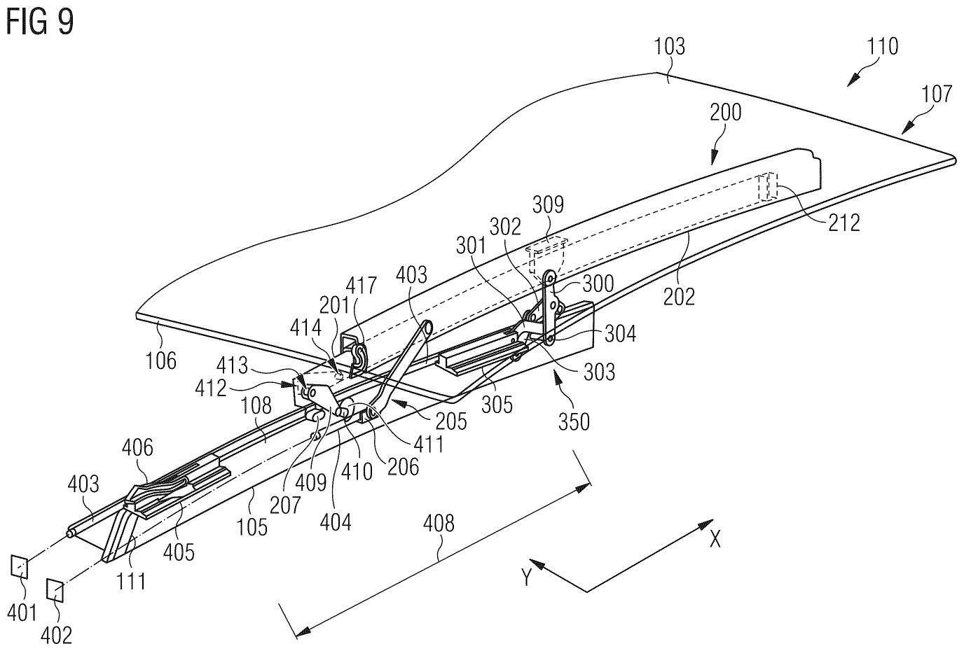

FIG. 9 shows the arrangement 110 according to another exemplary embodiment in a partially open position between the closing position and the open position.

The arrangement 110 has a first drive motor 401 and a second drive motor 402. The two drive motors 401, 402 each have, for example, an electric motor and, for example, a gearbox. A first drive cable 403 is coupled to the first drive motor 401. Another drive cable 404 is coupled to the second drive motor 402. The two drive cables 403, 404 are each tension- and pressure-resistant drive cables, which are designed to transfer a rotational movement of the respective drive motors 401, 402 into a linear movement.

The first drive motor 401 is connected to the deployment carriage 305 by means of the first drive cable 403. Thus, the deployment carriage 305 is displaceable along the longitudinal direction X relative to the guide rail 105 by means of the first drive motor 401.

In addition, the arrangement 110 has a lifting carriage 405. The lifting carriage 405 is also connected to the first drive motor 401. The lifting carriage 405 has a carriage slotted guide mechanism 406.

The lifting carriage 406 and the deployment carriage 305 are both connected to the common drive cable 403. The deployment carriage 305 and the lifting carriage 405 are at a carriage distance 408 to each other. For example, the carriage distance 408 is a distance between the centres of the respective carriages 305, 405. The carriage distance 408 can also be a distance between the two facing end sides of the two carriages 305, 405. The carriage distance 408 is fixedly predetermined and cannot be changed during the movement sequence for opening and closing the cover 103. The deployment carriage 305 and the lifting carriage 405 are fastened to the first drive cable 403 at the carriage distance 408 with respect to each other.

The cover support 200, in particular the first cover support rail 201, has a slotted guide mechanism pin 414. The slotted guide mechanism pin 414 projects along the transverse direction Y. The slotted guide mechanism pin 414 is arranged on a side of the first slotted guide support rail 201 facing away from the drive lever 205.

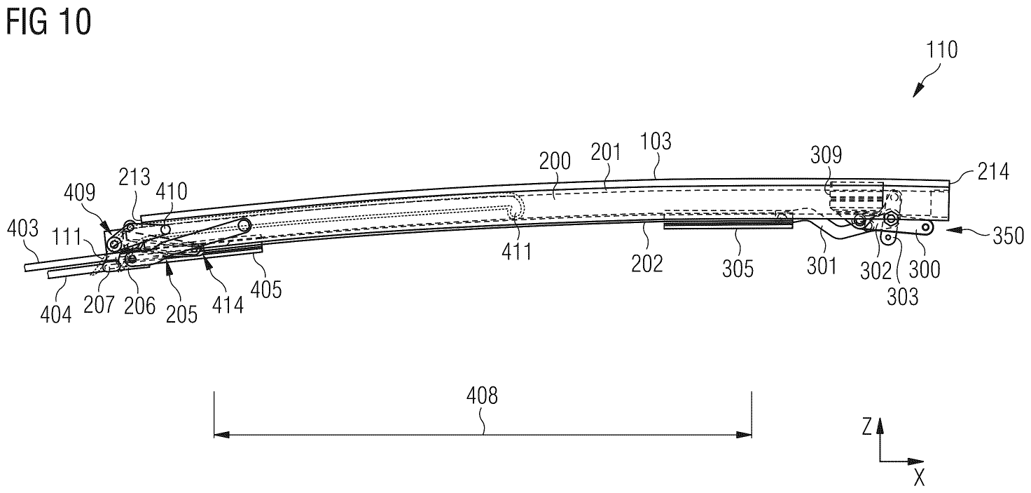

The carriage slotted guide mechanism 406 and the slotted guide mechanism pin 415 are designed for mutual engagement. In the closing position (also compare FIG. 10), the slotted guide mechanism pin 414 is arranged in the carriage slotted guide mechanism 406. To open the cover, at the start the lifting carriage 405 is moved rearwards along the longitudinal direction X from the closing position. In the process, the slotted guide mechanism pin 414 slides along the carriage slotted guide mechanism 406. Thus, in particular, the leading edge 106 is slightly lifted and optionally also slightly moved rearwards. This avoids crushing of a seal at the leading edge 106. In particular, the leading edge 106 is not lifted substantially along the vertical direction Z over the remaining vehicle roof 101 by the carriage slotted guide mechanism 406. The carriage slotted guide mechanism 406 and the lifting carriage 405 are used only to permit a neutral position, in particular at a central region along the transverse direction Y of the leading edge 406, while the trailing edge 107 is moved along the vertical direction Z. This is particularly useful for a curved cover 103, which has a curvature along the Y direction.

The lifting of the leading edge 106, before the cover 103 is displaceable along the longitudinal direction X in its open position, is effected by the interaction of the inclined slotted guide mechanism region 111 and the guide slider 207. While the guide slider 207 moves along the inclined slotted guide mechanism region 111 from the closing position towards the rectilinear slotted guide mechanism region 109, the slotted guide mechanism pin 414 is decoupled in particular from the carriage slotted guide mechanism 406 such that the slotted guide mechanism pin 414 is movable independently of the carriage slotted guide mechanism 406.

The movement of the lifting carriage 405 for moving the slotted guide mechanism pin 414 is driven simultaneously with the movement of the deployment carriage 305 by the first drive cable 403. Thus, the pivoting of the deployment lever 300 for lifting and lowering the trailing edge 107 is carried out simultaneously with the compensating movement of the leading edge 106 to avoid crushing of the seal.

The second electric motor 402 is connected to the drive carriage 206 by means of the second drive cable 400. By means of the second electric motor 402, the longitudinal displacement of the cover support 200, in particular of the second cover support rail 202, and thus of the cover 103, can thus be driven. When the deployment lever 300 is oriented along the vertical direction Z and when the slotted guide mechanism pin 414 is decoupled from the carriage slotted guide mechanism 406, the cover 103 is displaceable along the longitudinal direction X by means of the second drive motor 402. The kinetic energy of the second drive motor 402 is transmitted to the second cover support rail 202 by means of the second drive cable 404 and the drive carriage 206 and the drive lever 205.

The second cover support rail 202 is optionally latchable to and decouplable from the first cover support rail 201. The latching and decoupling is carried out by means of a locking lever 409. The locking lever 409 is fastened pivotably to the cover support 200, in particular to the first cover support rail 201. A locking pin 410 is provided at an end of the locking lever 409 facing away from the articulated fastening to the first cover support rail 201. The locking pin 410 interacts with a locking slotted guide 411 of the guide rail 105. The locking pin 410 projects along the transverse direction Y in a direction facing away from the cover support 200.

The locking lever 409 has a further locking pin 413. The further locking pin 413 and the locking pin 410 are arranged along the Y direction on opposite sides of the locking lever 409. The further locking pin 413 projects along the transverse direction Y in the direction of the cover support 200. The further locking pin 413 interacts with a cover support slotted guide mechanism 417 of the second cover support rail 202.

The coupling of the locking lever 409 to the first cover support rail 201 has, for example, a spring 412. The spring 412 may also be omitted. The spring exerts a force between the first cover support rail 201 and the locking lever 409 such that the end with the locking pin 410 is pushed away from the first cover support rail 201. The spring 412 thus has the effect that the locking lever 409, in particular the locking pin 410, is preloaded along the vertical direction Z in the direction of the guide rail and in particular into the locking slotted guide mechanism 410.

The deployment lever 300 is actuated by means of the deployment carriage 305 via the first lever 301 and the second lever 302. By means of the engagement of the deployment lever slider 309 into the cover support 200, the trailing edge 107 can thereby be lifted and lowered.

The lifting and lowering of the trailing edge 105 can also be realized with a different drive mechanism according to further exemplary embodiments, not explicitly illustrated. For example, in these exemplary embodiments, the deployment carriage 305 has a slotted guide mechanism track in which a pin of the deployment lever 301 engages. The pivoting of the deployment lever can be driven by means of the pin being guided in the slotted guide mechanism. The first lever 301 and the second lever 302 can be omitted in this exemplary embodiment.

The drive carriage 206 actuates the cover support 200, in particular the second cover support rail 202, by means of the drive lever 205. The second cover support rail 202 is mounted displaceably on the first cover support rail 201 in the position illustrated in FIG. 9. The second cover support rail carries out a longitudinal movement on the first cover support rail 201 and on the deployment lever slider 309 in order to displace the cover 103 along the longitudinal direction X.

The first cover support rail 201 is designed at its front rail end 211 with the guide slider 207, which is guided in the guide rail 105 and thus forms the front support of the cover 103.

By means of this displaceable arrangement of the second cover support rail 202, it is possible to push the cover 103 further rearwards together with the second cover support rail 202 on the first cover support rail 201 and thus to achieve an enlarged opening width.

FIG. 10 shows the arrangement 110 in the closing position. The guide slider 207 is arranged in the inclined slotted guide mechanism region 111. The further locking pin 413 is arranged in the cover support slotted guide mechanism 417. The third lever 303 is oriented substantially along the vertical direction Z such that the dead centre position described above is produced and the cover is held stably in the closing position, in particular in the rear region at the trailing edge 107. The deployment carriage 305, the lifting carriage 405 and the drive carriage 206 are each arranged in their forward position along the longitudinal direction X.

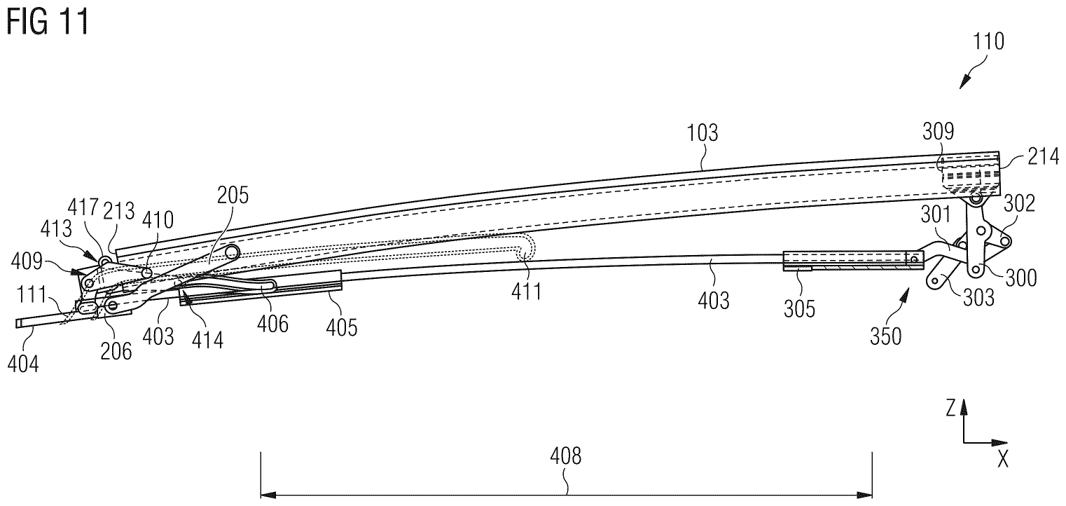

FIG. 11 shows the tilt position of the cover 103, in which the deployment lever 300 is pivoted and thus the trailing edge 107 of the cover 103 is lifted.

The deployment carriage 305 is displaced rearwards along the longitudinal direction X in comparison to the closing position according to FIG. 10. By means of the first lever 301, the second lever 302 and the third lever 303, the deployment lever 300 has thereby been moved into its position oriented substantially along the vertical direction Z.

Together with the deployment carriage 305, the lifting carriage 405 has been displaced rearwards along the longitudinal direction X in comparison to the closing position according to FIG. 10. As a result, the slotted guide mechanism pin 414 has been guided along the carriage slotted guide mechanism 406. Said slotted guide mechanism pin has the forwardly rising profile such that the front end of the cover support 211/213 has also been slightly lifted and thus the leading edge 106 of the cover retains a virtually unchanged position with respect to the seal. The trailing edge 107 has been lifted. As a result, the cover 103 is arranged in the inclined tilt position.

The drive carriage 206 and the drive lever 205 have been displaced rearwards a few millimetres along the longitudinal direction X in order to additionally reduce the crushing of the seal at the leading edge 106 and to permit the trailing edge 107 to pivot out.

In this position according to FIG. 11, the deployment carriage 305 and the lifting carriage 405 are locked relative to the guide rail 105, for example by means of the drive cable 403 and the first drive motor 401. According to further exemplary embodiments, further locking mechanisms such as locking levers or similar are provided to fix the position of the deployment carriage 305 and the lifting carriage 405 relative to the guide rail.

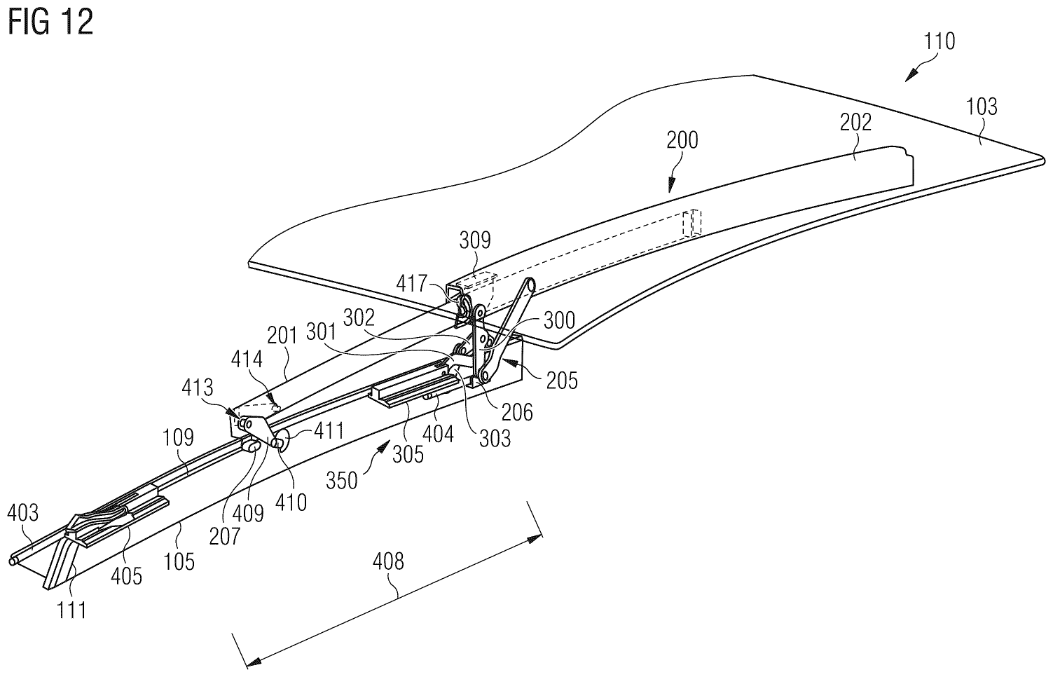

FIG. 12 shows the arrangement 110 in the open position.

Starting from the tilt position according to FIG. 11, the drive carriage 206 has been displaced rearwards along the longitudinal direction. By means of the drive lever 205, the cover support 200 has thus also been moved displaced rearwards. In a first movement section, the first cover support rail 201 and the second cover support rail 202 are locked together by means of the engagement of the further locking pin 413 in the cover support slotted guide mechanism 417, and therefore the movement of the drive lever 205 leads to the longitudinal displacement of the first cover support rail 201 rearwards along the longitudinal direction.

During this longitudinal displacement of the first cover support rail 201, the guide slider 207 is moved along the inclined slotted guide mechanism region 111 and the leading edge 106 of the cover 103 is thus lifted along the vertical direction Z. Subsequently, the guide slider 207 enters the rectilinear slotted guide mechanism region 109.

The first cover support rail 201 is moved rearwards together with the second cover support rail 202 until the locking pin 410 enters into engagement with the locking slotted guide mechanism 411 running substantially along the vertical direction Z. The locking lever 409 is pivoted such that the locking pin 410 is moved downwards into the locking slotted guide mechanism 411. In the process, the further locking pin 413 is moved out of the cover support slotted guide mechanism 417. Thus, the locking lever 409 is in engagement with the locking slotted guide mechanism 411 and is decoupled from the cover support slotted guide mechanism 417.

In this state (similarly to the state according to FIG. 9), the first cover support rail 201 is locked and held immovably relative to the guide rail 105 along the longitudinal direction X. The second cover support rail 202 is further displaced rearwards by the drive lever 205, in particular relative to the guide rail 105 and to the first cover support rail 201. In this case, the second cover support rail 202 is furthermore supported on the deployment lever 300 by means of the deployment lever slider 309.

The closing process of the cover from the open position according to FIG. 12 to the closing position according to FIG. 10 is carried out in reverse order.

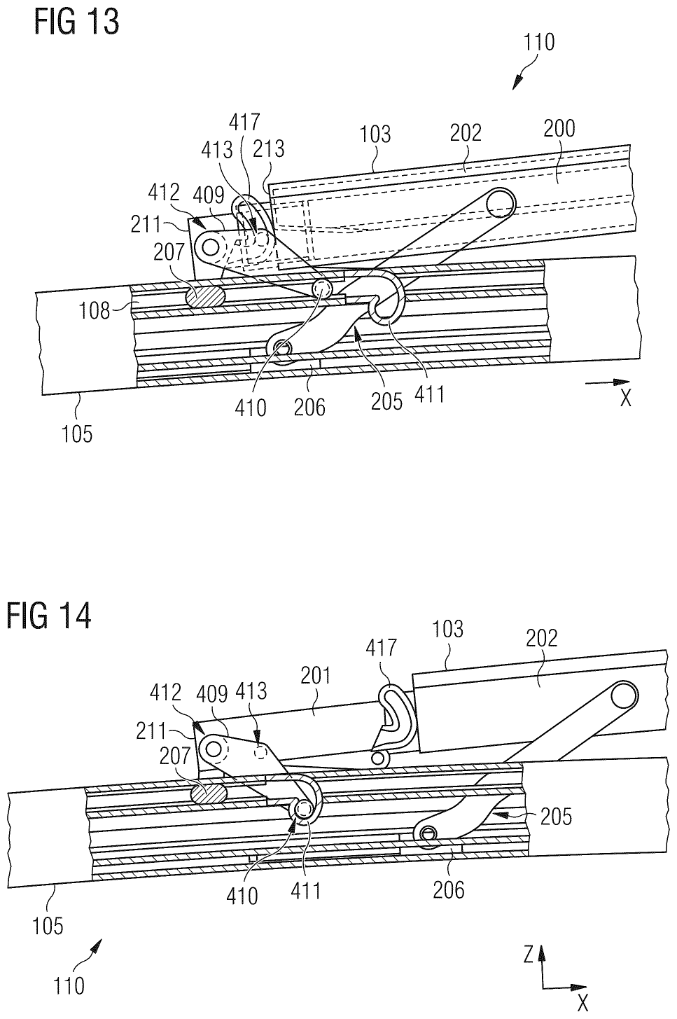

The locking of the first cover support rail 201 to the second cover support rail 202 and the guide rail 105 is also shown in detail once again in FIGS. 13 and 14.

In the state according to FIG. 13, the further locking pin 413 of the first cover support rail 201 is held in the cover support slotted guide mechanism 417 of the second cover support rail 201 such that the further locking pin 413 is not movable along the longitudinal direction X relative to the second cover support rail 202. Thus, the movement of the drive lever 205 along the longitudinal direction X from the second cover support rail 202 by means of the cover support slotted guide mechanism 417 and the further locking pin 413 is transmitted to the first cover support rail 201.

The locking pin 410 of the locking lever 409 is arranged in a rectilinear region of a guide track in the guide rail 105 and can thus be moved along the longitudinal direction X.

In the state according to FIG. 14, the first cover support rail 201 is locked to the guide rail 105 by means of the locking pin 410. The first cover support rail 201 is no longer coupled in a positionally fixed manner along the longitudinal direction X to the second cover support rail 202.

The other locking pin 413 is not in engagement with the cover support slotted guide mechanism 417. The locking pin 410 is in the locking slotted guide mechanism 411, which in particular has the section running along the longitudinal direction X, in which the locking pin 410 is arranged in order to fix the position of the first cover support rail 201 along the longitudinal direction X. The locking pin 410 is held in the position illustrated in the locking slotted guide mechanism 411 such that the locking pin 410 is not movable along the longitudinal direction X relative to the guide rail 105.

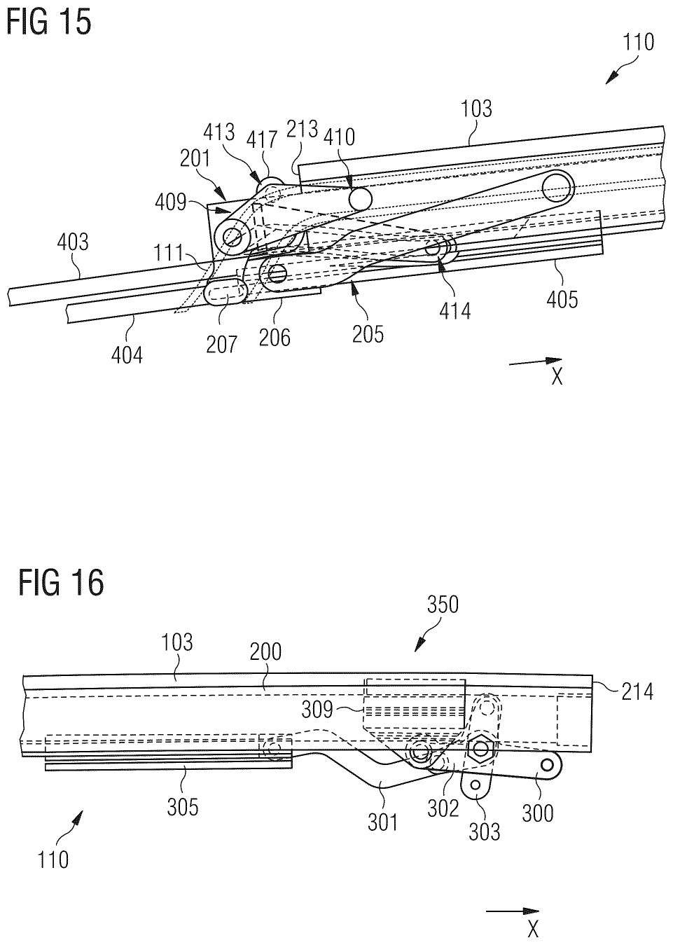

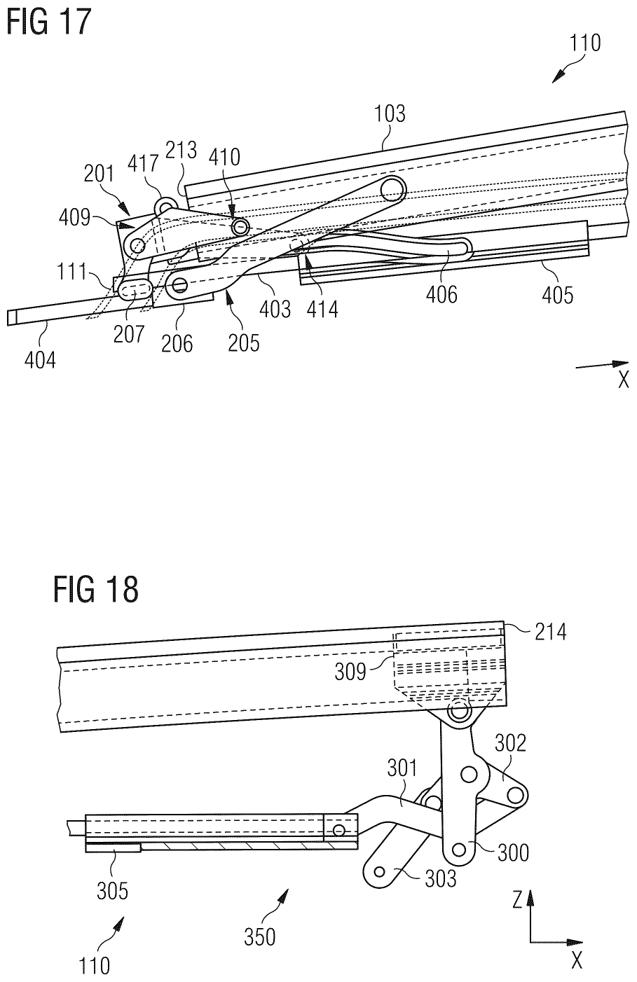

As can also be seen from FIGS. 15 to 18, the height of the trailing edge 107 of the cover 103 relative to the guide rail 105 is determined by the deployment lever 300. The latter is in a locked position by means of the positioning of the drive carriage 305 and the first, second and third levers 301, 302 and 303 coupled thereto in the closed position according to FIG. 16.

The height of the leading edge 106 of the cover 103 is determined by the position of the slotted guide mechanism pin 414 in the carriage slotted guide mechanism 406. In the closed position according to FIG. 15, the slotted guide mechanism pin 414 is arranged at a rear end of the carriage slotted guide mechanism 406 along the longitudinal direction X.

The position of the cover 103 along the longitudinal direction X in the closing position is determined by the resulting position of the guide slider 207 in the rail slotted guide mechanism 108 and in particular in the inclined slotted guide mechanism region 111 of the guide rail 105. The closing position of the arrangement 110 and thus of the cover 103 is thus completely and reproducibly precisely determined.

To lift the trailing edge 107, the deployment lever 300 is rotated into its vertical position according to FIG. 18.

In order to obtain the functionality of the seal at the leading edge 106 both in the deployed position of the deployment lever 300 according to FIG. 18 and in the intermediate positions between the two end positions according to FIGS. 16 and 18 and thus in the intermediate positions of the cover 103 between the closing position and the (open) TILT position, during the movement of the cover 103 at the trailing edge 107 between the positions according to FIGS. 16 and 18 a synchronous movement of the front end of the cover support 211/213 (remove: the leading edge 106 on a predetermined path) is realized. The front region of the cover support 200, in particular a region adjacent to the first rail end 211, is to this end lifted and lowered in a controlled manner along the vertical direction Z by means of the slotted guide mechanism pin 414 and the carriage slotted guide mechanism 406 and slides upwards over the further course on the path predetermined by the inclined slotted guide mechanism region 111.

During the pivoting movement of the deployment lever 300, driven by means of the drive cable 403, the drive carriage 206 is actively moved by the second drive motor 402 synchronously with respect to the deployment carriage 305. Alternatively, it is also possible to move the drive carriage 206 passively by a drive rod or coupling rod, as, for example, is coupled to the deployment carriage 305.

At the end of the lifting movement for the trailing edge 107, the slotted guide mechanism pin 414 is exposed and can move freely upwards driven by means of the drive carriage 206.

During the closing in the reverse direction, the carriage slotted guide mechanism 406 moves forwards along the longitudinal direction X. The front region at the first rail end 211 is lowered in a controlled manner by means of the carriage slotted guide mechanism 406 and the slotted guide mechanism pin 414 and slides downwards on the path predetermined by the inclined slotted guide mechanism region 111.

Starting from the tilt position, the drive carriage 206, driven by the second electric motor 402, is moved further rearwards for further displacement of the cover 103 along the longitudinal direction X rearwards. In the rear region, the second cover support rail 202 slides rearwards on the deployment lever slider 309. In the front region, the guide slider 207 is guided rearwards and upwards in the rail slotted guide mechanism 108 and then displaced along the longitudinal direction X further relative to the guide rail 105 into the rectilinear slotted guide mechanism region 109 by means of a linear movement. The cover 103 carries out a lifting movement at the leading edge 106 and then a pushing movement rearwards.

When the first rail end 211 reaches a central region of the guide rail 105, the first cover support rail 201 is uncoupled from the second cover support rail 202 during the further pushing movement rearwards and remains in a fixed position with respect to the guide rail 105. Subsequently, the second cover support rail 202 and thus the cover 103 are pushed rearwards to the maximum opening width.

The arrangement 110 with the two-part cover support 200, the locking by means of the locking lever 409, the two drive motors 401, 402 and the lifting mechanism with the deployment lever 300 and the three levers 301, 302, 303 permits an improved opening width for the roof opening 102. It is also possible to combine individual aspects of the described arrangement 110 with other embodiments of other aspects. For example, it is possible to provide only one single drive motor. As already explained, it is also possible, instead of the three levers 301, 302, 303 and the resultantly formed four-bar linkage, also to lift the deployment lever 300 by means of a slotted guide mechanism. It is also possible to use a one-piece cover support 200, which does not have two cover support rails that are displaceable with respect to each other.

The arrangement 110 according to the various exemplary embodiments with the comparatively large opening width nevertheless permits an efficient installation space requirement. Owing to the reliable support by the guide sliders 207 which can be arranged comparatively far forwards, the cover 103 can be formed with larger masses even in the open position. Thus, for example, additional functions that require a higher thickness of the cover 103 can be integrated, for example lighting functions and/or shading functions, which are electrically controllable, for example, and/or a roller blind integrated in the cover 103.

The distance between the front support point on the guide slider 207, the support point on the deployment lever 300 and the second rail end 212 projecting far rearwards permits a good supporting ratio and low lever forces. Thus, for example, even larger cover dimensions for the cover 103 can be realized. The carriage slotted guide mechanism 406 together with the slotted guide mechanism pin 414 and/or the lever mechanism with the deployment lever 300 and the three levers 301, 302, 303 permits, in particular during the closing and under the wind load, a reduced power requirement even with relatively large cover dimensions and/or larger masses of the cover 103.

The arrangement 110 thus permits reliable operation for moving the cover 103.

### REFERENCE SIGNS

100 Vehicle
101 Vehicle roof
102 Roof opening
103 Cover
104 Windscreen
105 Guide rail
106 Leading edge
107 Trailing edge
108 Rail slotted guide mechanism
109 Rectilinear slotted guide mechanism region
110 Arrangement
111 Inclined slotted guide mechanism region
112 Guide rail end
113 Lever track
200 Cover support
201 First cover support rail
202 Second cover support rail
203 First sliding track
204 Second sliding track
205 Drive lever
206 Drive carriage
207 Guide slider
208 Longitudinal extent first cover support rail
209 Longitudinal extent second cover support rail
210 First support distance
211 First rail end
212 Second rail end
213 Third rail end
214 Fourth rail end
215 Second support distance
216 Rail slider
217 Drive lever joint
300 Deployment lever
301 First lever
302 Second lever
303 Third lever
304 First rotary joint
305 Deployment carriage
306 Sixth rotary joint
307, 308 Straight line
309 Deployment lever slider
310 Distance
311 First end
312 Second end
313 Third end
314 Fourth end
315 Fifth end
316 Sixth end
317 Seventh end
318 Eighth end
319 Main direction of extent of the second lever
320 Angle
321 First section
322 Second section
323 Main direction of extent of the first lever
324 Curved profile
325 Second rotary joint
326 Third rotary joint
327 Fourth rotary joint
328 Fifth rotary joint
329 Main direction of extent of the deployment lever
330 Main direction of extent of the third lever
331 Seventh rotary joint
350 Articulation mechanism
401 First drive motor
402 Second drive motor
403 Drive cable
404 Further drive cable
405 Lifting carriage
406 Carriage slotted guide mechanism
407 Lifting pin
408 Carriage distance
409 Locking lever
410 Locking pin
411 Locking slotted guide mechanism
412 Spring
413 Further locking pin
414 Slotted guide mechanism pin
417 Cover support slotted guide mechanism
X Longitudinal direction
Y Transverse direction
Z Vertical direction

1. Arrangement for moving a cover for a vehicle roof, having:
a guide rail, which extends along a longitudinal direction,
a cover support, which is connectable to the cover,
a first drive motor,
a second drive motor,
a deployment lever, which is coupled in a positionally fixed manner to the guide rail such that the deployment lever is pivotable relative to the guide rail in order to move the cover support, the cover support being displaceable relative to the deployment lever along the longitudinal direction,
a drive lever, which is guided displaceably in the guide rail along the longitudinal direction and which is coupled to the cover support in order to displace the cover support along the longitudinal direction, wherein
the first drive motor is coupled to the deployment lever in order to drive a pivoting of the deployment lever, and
the second drive motor is coupled to the drive lever in order to drive a displacement of the drive lever.

2. Arrangement according to claim 1, having a deployment carriage, which is guided displaceably in the guide rail along the longitudinal direction, the deployment carriage being coupled to the deployment lever, and the deployment carriage being coupled to the first drive motor by means of a drive cable.

3. Arrangement according to claim 2, having a lifting carriage, which is coupled to the drive cable and which has a carriage slotted guide mechanism, wherein the cover support has a slotted guide mechanism pin which is guided at least in sections in the carriage slotted guide mechanism in order to move the cover.

4. Arrangement according to claim 2, in which the lifting carriage and the deployment carriage are at a fixed carriage distance from each other along the longitudinal direction.

5. Arrangement according to claim 2, having an articulation mechanism in order to transfer a displacement of the deployment carriage along the guide rail into a pivoting of the deployment lever, the articulation mechanism having at least four rotary joints.

6. Arrangement according to claim 1, having a drive carriage, which is guided displaceably in the guide rail along the longitudinal direction, the drive carriage being coupled to the drive lever, and the drive carriage being coupled to the second drive motor by means of a further drive cable.

7. Arrangement according to claim 1, having
a locking lever with a locking pin, the locking lever being arranged pivotably on the cover support, and
a locking slotted guide mechanism in the guide rail, wherein the locking pin can be arranged in the locking slotted guide mechanism in order to hold the locking lever along the longitudinal direction in a positionally fixed manner with respect to the guide rail.

8. Arrangement according to claim 7, having a spring, which preloads the locking lever in a direction directed away from the cover support.

9. Arrangement according to claim 7, in which the cover support has a first cover support rail and a second cover support rail, wherein the first cover support rail and the second cover support rail are locked together in a first state, so that a movement along the longitudinal direction can be transferred from the second cover support rail to the first cover support rail, and wherein the first cover support rail and the second cover support rail are displaceable relative to each other along the longitudinal direction in a second state, wherein the locking lever is arranged pivotably on the first cover support rail, and wherein the second cover support rail is fastenable rigidly to the cover.

10. Arrangement according to claim 9, in which the cover support has a guide slider, wherein the guide rail has a rail slotted guide mechanism, which has a slotted guide mechanism region oriented along the longitudinal direction and a slotted guide mechanism region inclined with respect to the longitudinal direction, wherein the guide slider is arranged in the inclined slotted guide mechanism region in a closing position of the arrangement.

11. Arrangement according to claim 10, in which the guide slider and the locking lever are arranged at a first rail end of the first cover support rail facing away from the deployment lever.

12. Arrangement according to claim 9, in which the second cover support rail has a slotted cover support guide, wherein the locking pin can be arranged in the slotted cover support guide in order to keep the locking lever in a fixed position with respect to the second support rail (202) along the longitudinal direction.

13. Vehicle roof, having:
an arrangement according to claim 1,
a cover, wherein the cover support is coupled to the cover in order to move the cover by means of the two drive motors.
